(19) United States
(12) Patent Application Publication
(10) Pub. No.: US 2011/0306723 A1
(43) Pub. Date: Dec. 15, 2011

(54) SILANE-TERMINATED POLYURETHANE POLYMERS

(75) Inventor: Fabien Choffat, Ruttenen (CH)

(73) Assignee: SIKA TECHNOLOGY AG, BAAR (CH)

(21) Appl. No.: 13/202,294

(22) PCT Filed: Feb. 18, 2010
(86) PCT No.: PCT/EP10/52011

§ 371 Date: Aug. 31, 2011

(30) Foreign Application Priority Data
Feb. 18, 2009 (EP) 09153120.2

(51) Int. Cl. C09D 175/08; C08G 18/08; C09J 175/08; C08G 18/83

(52) U.S. Cl. 524/590; 525/408; 525/404

(57) ABSTRACT

The present disclosure relates to novel polymers that are suitable for use in moisture-curing compositions based on silane functional polyurethane polymers. These compositions are used, for example, as adhesives, sealing materials or coatings.

### TECHNICAL FIELD

The present invention relates to the field of silane-terminated poly-urethane polymers, as used in elastic adhesives, sealants and coatings.

### STATE OF THE ART

Moisture-curing compositions based on silane-functional polymers have been used for some time as elastic adhesives, sealants and coatings. Since they are free of isocyanate groups, they constitute a preferred alternative to isocyanate-containing polyurethane compositions from a toxicological point of view.

Moisture-reactive polymers used are often silane-terminated polyurethane polymers as obtainable from the reaction of a polyurethane polymer having isocyanate groups with a silane having at least one organic group reactive toward isocyanate groups. The silanes are usually amino- or mercaptosilanes. Such silane-terminated polyurethane polymers, the use thereof as adhesives, sealants and coatings, and compositions comprising such polyurethane polymers, are widely known and described in the prior art.

At the same time, the silane-functional polyurethane polymers which are prepared with the aid of mercaptosilanes have the disadvantage of a very unpleasant odor. Silane-functional polyurethane polymers which are prepared with the aid of aminosilanes often have the disadvantage of relatively low elongation and inadequate storage stability, especially after thermal storage. In addition, they often have unfavorably high viscosities.

### SUMMARY OF THE INVENTION

It is therefore an object of the present invention to provide silane-functional polyurethane polymers for use in adhesives, sealants and coatings, which have improved or at least equivalent properties compared to the prior art.

It has now been found that, surprisingly, polymers as claimed in claim 1 achieve this object.

Such polymers are highly suitable for use as silane-terminated polyurethane polymers in moisture-curing compositions. One advantage of the use of novel silane-terminated polyurethane polymers is that they allow use of a broader selection of raw materials and starting materials for the preparation thereof. An additional factor is that the inventive compositions are odor-neutral and have good storage stability.

Further aspects of the invention are the subject of further independent claims. Particularly preferred embodiments of the invention are the subject of the dependent claims.

### Ways of Executing the Invention

In a first aspect, the present invention provides a polymer of the formula (I).

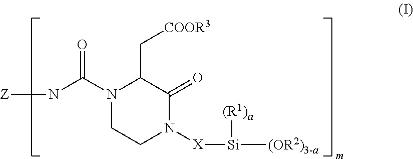

The R¹ radical here is a linear or branched monovalent hydrocarbyl radical which has 1 to 12 carbon atoms and optionally has one or more C—C multiple bonds and/or optionally cycloaliphatic and/or aromatic components.

The R² radical is an acyl radical or a linear or branched monovalent hydrocarbyl radical which has 1 to 12 carbon atoms and optionally has one or more C—C multiple bonds and/or optionally cycloaliphatic and/or aromatic components.

The index a is a value of 0, 1 or 2.

More particularly, the R² radical is independently a methyl or ethyl or isopropyl group, and the index a is a value of 0 or 1, especially of 0.

In addition, the R³ radical is a linear or branched monovalent hydrocarbyl radical having 1 to 12 carbon atoms. More particularly, the R³ radical is a methyl or ethyl group.

X is a linear or branched divalent hydrocarbyl radical which has 1 to 6 carbon atoms and optionally has one or more heteroatoms and optionally one or more C—C multiple bonds and/or optionally cycloaliphatic and/or aromatic components. More particularly, X is a methylene, n-propylene, 3-aza-n-hexylene or 3-aza-n-pentylene group.

Z is an m-valent radical of a polyurethane polymer PUR having isocyanate groups, after removal of m isocyanate groups.

The index m is a value of 1 to 4. More particularly, the index m is a value of 1 or 2.

Within a silane group in the polymer of the formula (I), R¹ and R² are each independently the radicals described. For example, polymers of the formula (I) with end groups which are ethoxydimethoxysilane end groups (R²=methyl, R²=methyl, R²=ethyl) are also possible.

Substance names beginning with “poly”, such as polyol or polyisocyanate, in the present document denote substances which, in a formal sense, contain two or more of the functional groups which occur in their names per molecule.

The term “polymer” in the present document firstly encompasses a collective of macromolecules which are chemically homogeneous but differ in relation to degree of polymerization, molar mass and chain length, which has been prepared by a poly reaction (polymerization, polyaddition, polycondensation). The term secondly also encompasses derivatives of such a collective of macromolecules from polyreactions, i.e. compounds which have been obtained by reactions, for example additions or substitutions, of functional groups onto given macromolecules, and which may be chemically homogeneous or chemically inhomogeneous. The term also encompasses what are called prepolymers, i.e. reactive oligomeric preliminary adducts whose functional groups are involved in the formation of macromolecules.

The term “polyurethane polymer” encompasses all polymers which are prepared by what is called the diisocyanate polyaddition process. This also includes those polymers which are virtually or entirely free of urethane groups. Examples of polyurethane polymers are polyether polyurethanes, polyester polyurethanes, polyether polyureas, polyureas, polyester polyureas, poly-isocyanurates and polycarbodiimides.

In the present document, the terms “silane” and “organosilane” denote compounds which have firstly at least one, typically two or three, alkoxy group(s) or acyloxy group(s) bonded directly to the silicon atom via Si—O bonds, and secondly at least one organic radical bonded directly to the silicon atom via an Si—C bond. Such silanes are also known to the person skilled in the art as organoalkoxysilanes or organoacyloxysilanes.

Correspondingly, the term “silane group” refers to the silicon-containing group bonded to the organic radical bonded via the Si—C bond. The silanes, or the silane groups thereof, have the property of being hydrolyzed on contact with moisture. This forms organosilanols, i.e. organosilicon compounds containing one or more silanol groups (Si—OH groups) and, by subsequent condensation reactions, organosiloxanes, i.e. organosilicon compounds containing one or more siloxane groups (Si—O—Si groups).

The term “silane-functional” refers to compounds which have silane groups. “Silane-functional polymers” are accordingly polymers which have at least one silane group.

“Aminosilanes” and “mercaptosilanes” refer, respectively, to organo-silanes whose organic radicals have an amino group and a mercapto group. “Primary aminosilanes” refer to aminosilanes which have a primary amino group, i.e. an NH₂ group bonded to an organic radical. “Secondary aminosilanes” refer to aminosilanes which have a secondary amino group, i.e. an NH group bonded to two organic radicals.

“Molecular weight” is understood in the present document always to mean the molecular weight average Mₙ (number average).

The polyurethane polymer PUR having isocyanate groups is especially obtainable from at least one polyol and at least one polyisocyanate.

This conversion can be effected by reacting the polyol and the polyisocyanate by customary processes, for example at temperatures of 50° C. to 100° C., optionally with additional use of suitable catalysts. More particularly, the polyisocyanate is metered in such that the isocyanate groups thereof are present in a stoichiometric excess in relation to the hydroxyl groups of the polyol.

More particularly, the excess of polyisocyanate is selected such that, in the resulting polyurethane polymer, after the conversion of all hydroxyl groups of the polyol, there remains a content of free isocyanate groups of 0.1 to 5% by weight, preferably 0.1 to 2.5% by weight, more preferably 0.2 to 1% by weight, based on the overall polymer.

If appropriate, the polyurethane polymer PUR can be produced with additional use of plasticizers, in which case the plasticizers used do not contain any groups reactive toward isocyanates.

Preference is given to polyurethane polymers PUR with the specified content of free isocyanate groups, which are obtained from the reaction of diisocyanates with high molecular weight diols in an NCO:OH ratio of 1.5:1 to 2.2:1.

Suitable polyols for the preparation of the polyurethane polymer PUR having isocyanate groups are especially polyether polyols, polyester polyols and polycarbonate polyols, and mixtures of these polyols.

The polyol is preferably a polyether polyol or a polyester polyol.

Suitable polyether polyols, also known as polyoxyalkylene polyols or oligoetherols, are especially those which are polymerization products of ethylene oxide, 1,2-propylene oxide, 1,2- or 2,3-butylene oxide, oxetane, tetrahydrofuran or mixtures thereof, optionally polymerized with the aid of a starter molecule having two or more active hydrogen atoms, for example water, ammonia or compounds with a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane-dimethanol, bisphenol A, hydrogenated bisphenol A, 1,1,1-trimethylolethane, 1,1,1-trimethylolpropane, glycerol, aniline and mixtures of the aforementioned compounds. It is possible to use either polyoxyalkylene polyols which have a low degree of unsaturation (measured to ASTM D-2849-69 and reported in milliequivalents of unsaturation per gram of polyol (meq/g)), prepared, for example, with the aid of what are called double metal cyanide complex catalysts (DMC catalysts), or polyoxyalkylene polyols with a higher degree of unsaturation, prepared, for example, with the aid of anionic catalysts such as NaOH, KOH, CsOH or alkali metal alkoxides.

Particularly suitable are polyoxyethylene polyols and polyoxypropylene polyols, especially polyoxyethylene diols, polyoxypropylene diols, polyoxyethylene triols and polyoxypropylene triols.

Especially suitable are polyoxyalkylene diols or polyoxyalkylene triols having a degree of unsaturation lower than 0.02 meq/g and having a molecular weight in the range from 1000 to 30 000 g/mol, and also polyoxyethylene diols, polyoxyethylene triols, polyoxypropylene diols and polyoxypropylene triols having a molecular weight of 400 to 20 000 g/mol.

Likewise particularly suitable are what are called ethylene oxide-terminated (“EO-endcapped”, ethylene oxide-endcapped) polyoxypropylene polyols. The latter are specific polyoxypropylenepolyoxyethylene polyols which are obtained, for example, by further alkoxylating pure polyoxypropylene polyols, especially polyoxypropylene diols and triols, with ethylene oxide after completion of the polypropoxylation reaction, and which thus have primary hydroxyl groups. Preference is given in this case to polyoxypropylenepolyoxyethylene diols and polyoxypropylenepolyoxyethylene triols.

Additionally suitable are polybutadiene polyols terminated by hydroxyl groups, for example those which are prepared by polymerization of 1,3-butadiene and allyl alcohol or by oxidation of polybutadiene, and the hydrogenation products thereof.

Additionally suitable are styrene-acrylonitrile-grafted polyether polyols, as commercially available, for example, under the Lupranol® tradename from Elastogran GmbH, Germany.

Especially suitable polyester polyols are polyesters which bear at least two hydroxyl groups and are prepared by known methods, more particularly by the polycondensation of hydroxycarboxylic acids or the polycondensation of aliphatic and/or aromatic polycarboxylic acids with di- or polyhydric alcohols.

Especially suitable are polyester polyols which are prepared from dihydric to trihydric alcohols, for example 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the aforementioned acids, and also polyester polyols from lactones, for example ε-caprolactone.

Polyester diols are particularly suitable, especially those prepared from adipic acid, azelaic acid, sebacic acid, dodecanedicarboxylic acid, dimer fatty acid, phthalic acid, isophthalic acid and terephthalic acid as dicarboxylic acid or from lactones, for example ε-caprolactone, and from ethylene glycol, diethylene glycol, neopentyl glycol, 1,4-butanediol, 1,6-hexanediol, dimer fatty acid diol and 1,4-cyclohexanedimethanol as dihydric alcohol.

Especially suitable as polycarbonate polyols are those of the kind obtainable by reaction, for example, of the abovementioned alcohols used to form the polyester polyols with dialkyl carbonates such as dimethyl carbonate, diaryl carbonates such as diphenyl carbonate or phosgene. Polycarbonate diols are particularly suitable, especially amorphous polycarbonate diols.

Further suitable polyols are poly(meth)acrylate polyols.

Additionally suitable are poly-hydroxy-functional fats and oils, for example natural fats and oils, especially castor oil, or polyols—known as oleochemical polyols—obtained by chemical modification of natural fats and oils, the epoxy polyesters or epoxy polyethers obtained, for example, by epoxidation of unsaturated oils and subsequent ring opening with carboxylic acids or alcohols, or polyols obtained by hydroformylation and hydrogenation of unsaturated oils. Additionally suitable are polyols obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are especially fatty acids and fatty alcohols, and also fatty acid esters, especially the methyl esters (FAME), which can be derivatized, for example, by hydroformylation and hydrogenation to hydroxy fatty acid esters.

Likewise suitable are additionally polyhydrocarbon polyols, also called oligohydrocarbonols, examples being poly-hydroxy-functional ethylene-propylene, ethylene-butylene or ethylene-propylene-diene copolymers, of the kind produced, for example, by Kraton Polymers, USA, or poly-hydroxy-functional copolymers of dienes such as 1,3-butadiene or diene mixtures and vinyl monomers such as styrene, acrylonitrile or isobutylene, or poly-hydroxy-functional polybutadiene polyols, examples being those which are prepared by copolymerizing 1,3-butadiene and allyl alcohol and which may also have been hydrogenated.

Additionally suitable are poly-hydroxy-functional acrylonitrile/butadiene copolymers of the kind which can be prepared, for example, from epoxides or amino alcohols and carboxyl-terminated acrylonitrile/butadiene copolymers which are commercially available under the Hypro® CTBN name (formerly Hycar) from Emerald Performance Materials, LLC, USA.

These polyols mentioned preferably have a mean molecular weight of 250 to 30 000 g/mol, especially of 1000 to 30 000 g/mol, and a mean OH functionality in the range from 1.6 to 3.

Particularly suitable polyols are polyester polyols and polyether polyols, especially polyoxyethylene polyol, polyoxypropylene polyol and polyoxy-propylene polyoxyethylene polyol, preferably polyoxyethylene diol, polyoxy-propylene diol, polyoxyethylene triol, polyoxypropylene triol, polyoxypropylene polyoxyethylene diol and polyoxypropylene polyoxyethylene triol.

In addition to these stated polyols, it is possible to use small amounts of low molecular weight dihydric or polyhydric alcohols, for example 1,2-ethanediol, 1,2- and 1,3-propanediol, neopentyl glycol, diethylene glycol, tri-ethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane-dimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned dihydric and polyhydric alcohols, and also mixtures of the aforementioned alcohols, when preparing the polyurethane polymer having terminal isocyanate groups.

The polyisocyanates used for the preparation of the polyurethane polymer may be commercial aliphatic, cycloaliphatic or aromatic polyiso-cyanates, especially diisocyanates.

For example, these are diisocyanates whose isocyanate groups are each bonded to an aliphatic, cycloaliphatic or arylaliphatic carbon atom, also called “aliphatic diisocyanates”, such as hexamethylene 1,6-diisocyanate (HDI), tetramethylene 1,4-diisocyanate, 2-methylpentamethylene 1,5-diiso-cyanate, 2,2,4- and 2,4,4-trimethylhexamethylene 1,6-diisocyanate (TMDI), dodecamethylene 1,12-diisocyanate, lysine diisocyanate and lysine ester diisocyanate, cyclohexane 1,3-diisocyanate, cyclohexane 1,4-diisocyanate, 1-isocyanato-3,3,5-tri methyl-5-isocyanatomethylcyclo hexane (=isophorone diisocyanate or IPDI), perhydrodiphenylmethane 2,4′-diisocyanate and perhydrodiphenylmethane 4,4′-diisocyanate, 1,4-diisocyanato-2,2,6-trimethylcyclohexane (TMCDI), 1,3- and 1,4-bis(isocyanatomethyl)cyclo-hexane, m- and p-xylylene diisocyanate (m- and p-XDI), m- and p-tetramethyl-xylylene 1,3-diisocyanate, m- and p-tetramethylxylylene 1,4-diisocyanate, bis(1-isocyanato-1-methylethyl)naphthalene; and diisocyanates with isocyanate groups each bonded to an aromatic carbon atom, also called “aromatic diisocyanates”, such as tolylene 2,4- and 2,6-diisocyanate (TDI), diphenylmethane 4,4′-, 2,4′- and 2,2′-diisocyanate (MDI), phenylene 1,3- and 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI); oligomers and polymers of the aforementioned isocyanates, and any desired mixtures of the aforementioned isocyanates.

The diisocyanate is preferably diphenylmethane diisocyanate (MDI), tolylene diisocyanate (TDI), hexamethylene 1,6-diisocyanate (HDI) or 1-iso-cyanato-3,3,5-trimethyl-5-isocyanatomethylcyclohexane (IPDI).

In a further aspect, the present invention relates to a process for preparing a polymer of the formula (I) as described above, comprising the steps of
i) reacting an aminosilane AS of the formula (II)

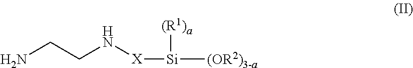

with a maleic or fumaric diester of the formula (III)

R³OOC—CH═CH—COOR³ (III)
ii) reacting the reaction product from step i) with an isocyanate-containing polyurethane polymer having m isocyanate groups.

The R¹, R², R³, X radicals and the indices a and m have already been described above.

The reaction of the aminosilane AS of the formula (II) with the maleic or fumaric diester of the formula (III) in step i) of the process for preparing a polymer of the formula (I) is effected preferably within a temperature range from 0 to 140° C., preferably from 40 to 100° C. The ratios are generally selected in such a way that the starting compounds are used in the stoichiometric ratio of about 1:1.

In the reaction, there is first an addition of the maleic or fumaric diester of the formula (III) onto the NH₂ group of the aminosilane AS. Such reactions of primary aminosilanes with maleic or fumaric diesters are also referred to as Michael-type addition reactions and are known to the person skilled in the art. For example, they are described in U.S. Pat. No. 5,364,955, the entire disclosure of which is hereby incorporated by reference.

After the addition reaction, there is an intramolecular condensation reaction with elimination of the alcohol R³—OH. This forms a piperazinone derivative of the formula (IV).

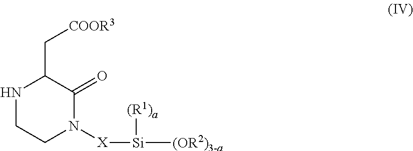

Such piperazinone derivatives are likewise known to the person skilled in the art and are described, for example, in U.S. Pat. No. 6,599,354 B1, the entire disclosure of which is hereby incorporated by reference.

The reaction of the aminosilane AS of the formula (II) with the maleic or fumaric diester of the formula (III) can be performed in substance or else in the presence of solvents, for example dioxane. However, the additional use of solvents is less preferred.

It will be appreciated that it is also possible to react mixtures of different aminosilanes AS of the formula (II) with mixtures of fumaric and/or maleic esters.

The alcohol R³—OH formed in the cyclocondensation reaction can, if required, be removed from the reaction mixture by distillation. The resulting silane-functional piperazinone derivatives of the formula (IV) are colorless liquids which, after distillative removal of the alcohol R³—OH, are obtained in such high purity that a distillative workup is generally unnecessary.

The reaction of the reaction product from step i) with the isocyanate-containing polyurethane polymer PUR having m isocyanate groups is effected in a process very well known to the person skilled in the art, preferably in a stoichiometric ratio of the secondary amino group, reactive toward isocyanate groups, of the piperazinone derivative to the isocyanate groups of the polyurethane polymer PUR of 1:1, or with a slight excess of amino groups reactive toward isocyanate groups, such that the resulting silane-functional polymer of the formula (I) is entirely free of isocyanate groups.

For example, the reaction of the polyurethane polymer PUR with the reaction product from step i) is effected within a temperature range from 0 to 150° C., especially from 20 to 80° C. The reaction time depends on factors including the starting materials used and on the reaction temperature selected, and so the course of the reaction is typically monitored by means of IR spectroscopy in order to determine the end of the reaction. The reaction is preferably stopped as soon as no free isocyanate groups are detectable any longer in the reaction mixture. In a preferred embodiment, no catalyst is used for this reaction.

In a further aspect, the present invention relates to the use of a reaction product from the reaction of an aminosilane AS of the formula (II)

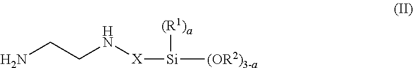

with a maleic or fumaric diester of the formula (III)

R³OOC—CH═CH—COOR³ (III)

as a reaction partner for polyurethane polymers having isocyanate groups or for polyisocyanates in the preparation of silane-functional polymers.

The R¹, R², R³, X radicals and the index a have already been described above.

The present invention further relates to a composition for production of adhesives, sealants or coatings comprising at least one polymer of the formula (I) as described above.

Typically, the silane-functional polymer is present in an amount of 10 to 80% by weight, preferably in an amount of 15 to 70% by weight, based on the overall composition.

The composition preferably further comprises at least one filler. The filler influences both the rheological properties of the uncured composition and the mechanical properties and the surface characteristics of the cured composition. Suitable fillers are inorganic and organic fillers, for example natural, ground or precipitated calcium carbonates optionally coated with fatty acids, especially stearic acid, barium sulfate (BaSO₄, also called barite or heavy spar), calcined kaolins, aluminas, aluminum hydroxides, silicas, especially finely divided silicas from pyrolysis processes, carbon blacks, especially industrially produced carbon black, PVC powders or hollow spheres. Preferred fillers are calcium carbonates, calcined kaolins, carbon black, finely divided silicas and flame-retardant fillers such as hydroxides or hydrates, especially hydroxides or hydrates of aluminum, preferably aluminum hydroxide.

It is entirely possible and may even be advantageous to use a mixture of different fillers.

A suitable amount of filler is, for example, within the range from 20 to 60% by weight, preferably 30 to 60% by weight, based on the overall composition.

The inventive composition further comprises especially at least one catalyst for the crosslinking of the polymers of the formula (I) by means of moisture. Such catalysts are especially metal catalysts in the form of organotin compounds such as dibutyltin dilaurate and dibutyltin diacetylacetonate, titanium catalysts, amino-containing compounds, for example 1,4-diazabicyclo-[2.2.2]octane and 2,2′-dimorpholinodiethyl ether, aminosilanes and mixtures of the catalysts mentioned.

The inventive composition may additionally further comprise further constituents. For example, such constituents are plasticizers such as esters of organic carboxylic acids or anhydrides thereof, such as phthalates, for example dioctyl phthalate, diisononyl phthalate or diisodecyl phthalate, adipates, for example dioctyl adipate, azelates and sebacates, polyols, for example polyoxyalkylene polyols or polyester polyols, organic phosphoric and sulfonic esters or polybutenes; solvents; fibers, for example of polyethylene; dyes; pigments; rheology modifiers such as thickeners or thixotropic agents, for example urea compounds of the type described as “thixotropy endowing agents” in WO 02/48228 A2 on pages 9 to 11, polyamide waxes, bentonites or fumed silicas; adhesion promoters, for example epoxysilanes, (meth)acryloylsilanes, anhydridosilanes or adducts of the aforementioned silanes with primary aminosilanes, and aminosilanes or ureasilanes; crosslinkers, for example silane-functional oligo- and polymers; desiccants, for example vinyltrimethoxysilane, α-functional silanes such as N-(silylmethyl) O-methylcarbamates, especially N-(methyldimethoxysilylmethyl) O-methylcarbamate, (methacryloyloxymethyl)silanes, methoxymethylsilanes, N-phenyl-, N-cyclohexyl- and N-alkylsilanes, orthoformic esters, calcium oxide or molecular sieves; stabilizers, for example against heat, light and UV radiation; flame-retardant substances; surface-active substances such as wetting agents, leveling agents, deaerating agents or defoamers; biocides such as algicides, fungicides or fungal growth-inhibiting substances; and further substances used customarily in moisture-curing compositions.

It is additionally possible if appropriate to use what are called reactive diluents, which are incorporated into the polymer matrix in the course of curing of the composition, especially by reaction with the silane groups.

It is advantageous to select all constituents which have been mentioned and may be present in the composition, especially filler and catalyst, such that the storage stability of the composition is not adversely affected by the presence of such a constituent, which means that the properties of the composition, especially the application and curing properties, are altered only slightly, if at all, in the course of storage. This means that reactions which lead to chemical curing of the composition described, especially of the silane groups, do not occur to a significant degree during the storage. It is therefore especially advantageous that the constituents mentioned contain, or release in the course of storage, at most traces of water, if any. It may therefore be advisable to chemically or physically dry certain constituents before mixing them into the composition.

The above-described composition is preferably produced and stored with exclusion of moisture. The composition is typically storage-stable, which means that it can be stored with exclusion of moisture in a suitable package or arrangement, for example a drum, a pouch or a cartridge, over a period of several months up to one year or longer, without any change to a degree relevant for the use thereof in the performance properties thereof or in the properties thereof after curing.

The storage stability of the compositions can be estimated firstly via the expulsion force and secondly via the skin formation time. A significant increase in the expulsion force and/or the skin formation time after storage of the compositions indicates poor storage stability.

The storage stability can likewise be determined via the viscosity of the composition or via the viscosity of the reactive polymer of the formula (I) used in the composition.

When the composition described is applied to at least one solid or article, the silane groups of the polymer come into contact with moisture. The silane groups have the property of being hydrolyzed on contact with moisture. This forms organosilanols and, by subsequent condensation reactions, organosiloxanes. As a result of these reactions, which can be accelerated by the use of catalysts, the composition ultimately cures. This process is also referred to as crosslinking.

The water required for the curing can either originate from the air (air humidity), or else the above-described composition can be contacted with a water-containing component, for example by painting, for example with a smoothing agent, or by spraying, or a water-containing component can be added to the composition on application, for example in the form of an aqueous paste which is mixed in, for example, by means of a static mixer. In the case of curing by means of air humidity, the composition cures from the outside inwards. The rate of curing is determined by various factors, for example the diffusion rate of the water, the temperature, the ambient humidity and the adhesive geometry, and generally slows with advancing curing.

The present invention further encompasses the use of an above-described composition as an adhesive, sealant or coating.

The inventive composition is especially used in a process for bonding two substrates S1 and S2, comprising the steps of
i′) applying a composition as described above to a substrate S1 and/or a substrate S2;
ii′) contacting the substrates S1 and S2 via the composition applied within the open time of the composition;
iii′) curing the composition by means of water, especially in the form of air humidity;
   where the substrates S1 and S2 are the same or different.

Preferably, the inventive composition is also used in a process for sealing or coating, comprising the steps of
i″) applying a composition as described above to a substrate S1 and/or between two substrates S1 and S2;
ii″) curing the composition by means of water, especially in the form of air humidity;
   where the substrates S1 and S2 are the same or different.

Suitable substrates S1 and/or S2 are especially substrates selected from the group consisting of concrete, mortar, brick, tile, gypsum, natural stone such as granite or marble, glass, glass ceramic, metal or metal alloy, wood, plastic and paint.

The inventive composition preferably has a pasty consistency with structurally viscous properties. Such a composition is applied to the substrate by means of a suitable device, for example in the form of a bead, which advantageously has an essentially round or triangular cross-sectional area. Suitable methods for application of the composition are, for example, application from commercially standard cartridges which are operated manually or by means of compressed air, or from a drum or hobbock by means of a delivery pump or of an extruder, optionally by means of an application robot. An inventive composition with good application properties has high creep resistance and forms short strings. This means that it remains in the form applied after application, i.e. does not flow apart, and forms only a very short thread, if any, after the removal of the application unit, such that the substrate is not soiled.

The invention further relates to a cured composition obtainable by the reaction of an above-described composition with water, especially in the form of air humidity.

The articles which are adhesive bonded, sealed or coated with an inventive composition are especially a building or a built structure in construction or civil engineering, an industrially manufactured good or a consumer good, especially a window, a domestic appliance, or a mode of transport, especially a vehicle, or an installed component of a vehicle.

### EXAMPLES

Working examples are adduced hereinafter, which are intended to illustrate the invention described in detail. It will be appreciated that the invention is not restricted to these working examples described.

### Test Methods

Tensile strength, elongation at break and modulus of elasticity at 0 to 100% extension were determined to DIN EN 53504 (pulling speed: 200 mm/min) on films with a layer thickness of 2 mm, which cured at 23° C. (room temperature, “RT”) and 50% relative air humidity over the course of 7 days and were additionally stored under the conditions specified in Table 1 over the course of 4 weeks.

Shore A hardness was determined to DIN 53505.

Storage stability was determined via the measurement of the viscosities of the particular silane-functional polyurethane polymers after different storages. For this purpose, the silane-functional polyurethane polymers were dispensed into aluminum tubes with exclusion of air. After storage at room temperature for one day (1d RT), 7 days (7d RT) and 14 days (14d RT), and after storage in an oven at 60° C. for 14 days (14d 60° C.), the viscosity at 20° C. was determined on a thermostated RC30 cone-plate rheometer from Rheotec GmbH, Germany (cone diameter 20 mm, cone angle 1°, cone tip-plate distance 0.05 mm, shear rate 50 s⁻¹).

### Preparation of the Piperazinone Derivatives of the Formula (IV)

At approx. 50° C., 1 mol of aminosilane was initially charged and then 1 mol of maleic diester was added gradually. The mixture heats up in the course of the addition to approx. 60° C. Stirring was continued at this temperature over the course of 10 hours until the two C═O band ratios in the IR spectrum no longer changed (band at approx. 1650 cm⁻¹ for the C═O vibration in the piperazinone ring and at approx. 1750 cm⁻¹ for C═O vibration in the alkyl ester radical).

The following piperazinone derivatives were prepared:

S-1 with difunctional aminosilane (obtainable under the Silquest® A-1120 trade name from Momentive Performance Materials Inc., USA) and dimethyl maleate (obtainable from Fluka Chemie GmbH, Switzerland);

S-2 with difunctional aminosilane (Silquest® A-1120) and diethyl maleate (obtainable from Fluka Chemie GmbH, Switzerland);

S-3 with trifunctional aminosilane (obtainable under the Silquest® A-1130 trade name from Momentive Performance Materials Inc., USA) and diethyl maleate (obtainable from Fluka Chemie GmbH, Switzerland).

The reactive silanes used were, in addition to the above-described piperazinone derivatives S-1, S-2 and S-3, the following silanes (reference examples):

S-4: difunctional aminosilane (Silquest® A-1120);

S-5: aminosilane (Silquest® A-1110 from Momentive Performance Materials Inc., USA);

S-6: mercaptosilane (Dynasylan® MTMO from Evonik Degussa GmbH, Germany).

### Preparation of the Silane-Functional Polyurethane Polymers PS-1 to PS-6

Under a nitrogen atmosphere, 700 g of Acclaim® 12200 polyol (Bayer MaterialScience AG, Germany; low monool polyoxypropylene diol; OH number 11.0 mg KOH/g; water content approx. 0.02% by weight), 31.7 g of isophorone diisocyanate (IPDI; Vestanat® IPDI, Evonik Degussa GmbH, Germany), 85.4 g of 2,2,4-trimethyl-1,3-pentanediol diisobutyrate (Eastman TXIB; Eastman Chemical Company, USA) and 0.1 g of di-n-butyltin dilaurate (Metatin® K 712, Acima AG, Switzerland) were heated to 90° C. while stirring constantly and left at this temperature. After a reaction time of one hour, by means of titration, a free content of isocyanate groups of 0.70% by weight was attained. Subsequently, a further 0.14 mol of reactive silane was added and stirring continued at 90° C. for a further 2 to 3 hours. The reaction was stopped as soon as no free isocyanate was detectable any longer by means of IR spectroscopy (2275-2230 cm⁻¹). The product was cooled to room temperature (23° C.) and stored with exclusion of moisture (theoretical polymer content=90%).

In the silane-functional polyurethane polymer PS-1, the reactive silane S-1 was used, in PS-2 the reactive silane S-2, in PS-3 the reactive silane S-3, in PS-4 (reference) the reactive silane S-4, in PS-5 (reference) the reactive silane S-5, and in PS-6 (reference) the reactive silane S-6.

TABLE 1
Viscosities of the polymers PS-1 to PS-6 prepared after different storages;

| | | PS-1 | PS-2 | PS-3 | PS-4 | PS-5 | PS-6 |
|---|---|---|---|---|---|---|---|
| Viscosity [Pa · s] | 1 d RT | 100 | 21 | 128 | gel ^{a)} | 50 | 30 |
| | 7 d RT | 140 | 49 | 130 | gel ^{a)} | 82 | 35 |
| | 14 d RT | 134 | 63 | 150 | gel ^{a)} | gel ^{a)} | 29 |
| | 14 d 60° C. | 117 | 69 | 200 | gel ^{a)} | gel ^{a)} | 50 |

^{a)} gel = these polymers gelated.

The silane-functional polyurethane polymer PS-4 (reference) gelates as early as during production, which makes it impossible to use such a polymer for adhesives and sealants.

The silane-functional polyurethane polymer PS-5 (reference) already gelates after storage at room temperature for 14 days. For an adhesive or sealant, such short storage stability is unfavorable.

Production of the Thixotropic Agent TM A vacuum mixer was initially charged with 1000 g of diisodecyl phthalate (Palatinol® Z, BASF SE, Germany) and 160 g of diphenylmethane 4,4′-diisocyanate (Desmodur® 44 MC L, Bayer MaterialScience AG, Germany), and heated gently. Then 90 g of monobutylamine were gradually added dropwise while stirring vigorously. Stirring of the resulting white paste continued under reduced pressure while cooling for a further hour. The thixotropic agent TM contains 20% by weight of thixotropic agent in 80% by weight of diisodecyl phthalate.

### Production of the Adhesives

In a vacuum mixer, according to the proportions by weight specified in Table 2, the silane-functional polyurethane polymer (PS-1 to PS-3, and PS-5 and PS-6), thixotropic agent TM, vinyltrimethoxysilane (Dynasylan® VTMO, Evonik Degussa GmbH, Germany), UV stabilizer (Tinuvin® 292, Ciba SC, Switzerland), antioxidant (Tinuvin® 1130, Ciba SC, Switzerland) and the plasticizer diisodecyl phthalate (Jayflex DIDP, Exxon Mobil, USA) were mixed thoroughly over the course of 5 minutes. Subsequently, dried precipitated chalk (Socal® U1S2, Solvay SA, Belgium), dried hydrophilic fumed silica (Aerosil 200, Evonik, Germany) and white pigment (titanium dioxide, Kronos 2500, Kronos International, USA) were incorporated by kneading at 60° C. over the course of 15 minutes. With the heating switched off, 8 g of N-(2-aminoethyl)-(3-aminopropyl)trimethoxysilane (Silquest® A-1120) and 1.6 g of di-n-butyltin dilaurate (Metatin® K712) were subsequently processed under reduced pressure over the course of 10 minutes to give a homogeneous paste. This was then dispensed into internally coated aluminum gun application cartridges.

The silane-functional polyurethane polymer PS-4 (reference) was not used to produce an adhesive since PS-4 already gelated, i.e. crosslinked, in the course of production (cf. Table 1).

TABLE 2
Composition in parts by weight and results

| | 1 | 2 | 3 | Ref1 | Ref2 |
|---|---|---|---|---|---|
| PS-1 | 30 | | | | |
| PS-2 | | 30 | | | |
| PS-3 | | | 30 | | |
| PS-5 | | | | 30 | |
| PS-6 | | | | | 30 |
| Thixotropic agent ™ | 4.5 | 4.5 | 4.5 | 4.5 | 4.5 |
| Dynasylan ® VTMO | 2 | 2 | 2 | 2 | 2 |
| Tinuvin ® 292 | 0.25 | 0.25 | 0.25 | 0.25 | 0.25 |
| Tinuvin ® 1130 | 0.25 | 0.25 | 0.25 | 0.25 | 0.25 |
| Socal ® U1S2 | 40 | 40 | 40 | 40 | 40 |
| Aerosil ® 200 | 2 | 2 | 2 | 2 | 2 |
| Kronos ® 2500 | 4 | 4 | 4 | 4 | 4 |
| Dynasylan ® DAMO-T | 1 | 1 | 1 | 1 | 1 |
| Metatin ® K712 | 0.1 | 0.1 | 0.1 | 0.1 | 0.1 |

Mechanical properties

| | | | | | | |
|---|---|---|---|---|---|---|
| Tensile strength | 7 d RT + 4 w RT | 1.87 | 1.78 | 1.94 | 2.04 | 2.11 |
| [MPa] | | | | | | |
| | 7 d RT + 4 w 70° C. | 1.99 | 1.65 | 1.79 | 1.77 | 1.74 |
| | 7 d RT + 4 w 80° C. | 1.81 | 1.58 | 1.76 | 1.80 | 1.28 |
| | 7 d RT + 4 w 9° C. | 1.65 | 1.52 | 1.65 | 1.61 | 0.76 |
| Elongation at break | 7 d RT + 4 w RT | 269 | 183 | 153 | 187 | 284 |
| [%] | | | | | | |
| | 7 d RT + 4 w 70° C. | 279 | 210 | 160 | 178 | 260 |
| | 7 d RT + 4 w 80° C. | 280 | 218 | 191 | 209 | 218 |
| | 7 d RT + 4 w 90° C. | 282 | 234 | 204 | 208 | 161 |
| Modulus of elasticity | 7 d RT + 4 w RT | 0.97 | 1.17 | 1.41 | 1.35 | 1.11 |
| 0-100% [MPa] | | | | | | |
| | 7 d RT + 4 w 70° C. | 1.00 | 0.98 | 1.25 | 1.17 | 0.88 |
| | 7 d RT + 4 w 80° C. | 0.89 | 0.91 | 1.11 | 1.09 | 0.72 |
| | 7 d RT + 4 w 90° C. | 0.80 | 0.81 | 0.97 | 0.97 | 0.49 |
| Shore A hardness | 14 d RT | 36 | 39 | 44 | 46 | 43 |

The example Ref1 has the disadvantage compared to the inventive examples that it has a lower storage stability in addition to the comparatively low elongation (cf. Table 1).

The example Ref2 compared to the inventive examples has the disadvantage that the composition has a very unpleasant odor.

1. A polymer of the formula (I) 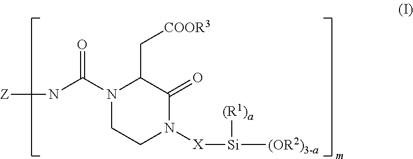
where
R¹ radical is a linear or branched monovalent hydrocarbyl radical which has 1 to 12 carbon atoms and optionally has one or more C—C multiple bonds and/or optionally cycloaliphatic and/or aromatic components;
R² radical is an acyl radical or a linear or branched monovalent hydrocarbyl radical which has 1 to 12 carbon atoms and optionally has one or more C—C multiple bonds and/or optionally cycloaliphatic and/or aromatic components;
index a is a value of 0, 1 or 2;
R³ radical is a linear or branched monovalent hydrocarbyl radical having 1 to 12 carbon atoms;
X is a linear or branched divalent hydrocarbyl radical which has 1 to 6 carbon atoms and optionally has one or more heteroatoms and optionally one or more C—C multiple bonds and/or optionally cycloaliphatic and/or aromatic components;
Z is an m-valent radical of a polyurethane polymer PUR having isocyanate groups after removal of m isocyanate groups; and
index m is a value of 1 to 4.

2. A polymer as claimed in claim 1, wherein the R² radical is independently a methyl or ethyl or isopropyl group and the index a is a value of 0 or 1.

3. A polymer as claimed in claim 1, wherein the R³ radical is a methyl or ethyl group.

4. A polymer as claimed in claim 1, wherein X is a methylene, n-propylene, 3-aza-n-hexylene or 3-aza-n-pentylene group.

5. A polymer as claimed in claim 1, wherein the index m is a value of 1 or 2.

6. A polymer as claimed in claim 1, wherein a polyurethane polymer PUR is obtainable from at least one polyol and at least one polyisocyanate, said polyisocyanate being metered in such that the isocyanate groups thereof are present in a stoichiometric excess in relation to the hydroxyl groups of the polyol.

7. A polymer as claimed in claim 6, wherein the polyol is a polyether polyol or a polyester polyol.

8. A polymer as claimed in claim 6, wherein the diisocyanate is diphenylmethane diisocyanate (MDI), tolylene diisocyanate (TDI), hexamethylene 1,6-diisocyanate (HDI) or 1-isocyanato-3,3,5-trimethyl-5-isocyanatomethylcyclohexane (IPDI).

9. A process for preparing a polymer of a formula (I): 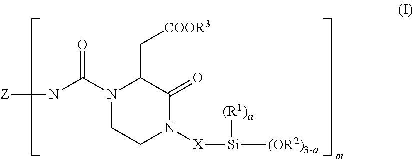
where
R¹ radical is a linear or branched monovalent hydrocarbyl radical which has 1 to 12 carbon atoms and optionally has one or more C—C multiple bonds and/or optionally cycloaliphatic and/or aromatic components;
R² radical is an acyl radical or a linear or branched monovalent hydrocarbyl radical which has 1 to 12 carbon atoms and optionally has one or more C—C multiple bonds and/or optionally cycloaliphatic and/or aromatic components;
index a is a value of 0, 1 or 2;
R³ radical is a linear or branched monovalent hydrocarbyl radical having 1 to 12 carbon atoms;
X is a linear or branched divalent hydrocarbyl radical which has 1 to 6 carbon atoms and optionally has one or more heteroatoms and optionally one or more C—C multiple bonds and/or optionally cycloaliphatic and/or aromatic components;
Z is an m-valent radical of a polyurethane polymer PUR having isocyanate groups after removal of m isocyanate groups; and
index m is a value of 1 to 4, the process comprising:
i) reacting an aminosilane AS of the formula (II) 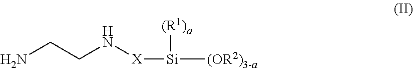
with a maleic or fumaric diester of the formula (III)
R³OOC—CH═CH—COOR³ (III)
ii) reacting the reaction product from step i) with an isocyanate-containing polyurethane polymer having m isocyanate groups.

10. A process comprising:
producing a reaction product from the reaction of an aminosilane AS of a formula (II): 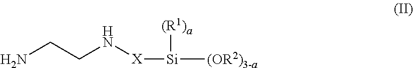
with a maleic or fumaric diester of the formula (III)
R³OOC—CH═CH—COOR³ (III)
where R¹, R², R³, X radicals and an index a are each as defined by the formula: 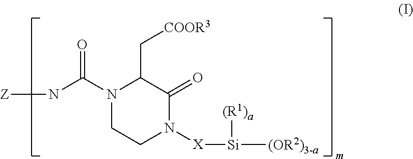
where
R¹ radical is a linear or branched monovalent hydrocarbyl radical which has 1 to 12 carbon atoms and optionally has one or more C—C multiple bonds and/or optionally cycloaliphatic and/or aromatic components;
R² radical is an acyl radical or a linear or branched monovalent hydrocarbyl radical which has 1 to 12 carbon atoms and optionally has one or more C—C multiple bonds and/or optionally cycloaliphatic and/or aromatic components;
index a is a value of 0, 1 or 2;
R³ radical is a linear or branched monovalent hydrocarbyl radical having 1 to 12 carbon atoms;
X is a linear or branched divalent hydrocarbyl radical which has 1 to 6 carbon atoms and optionally has one or more heteroatoms and optionally one or more C—C multiple bonds and/or optionally cycloaliphatic and/or aromatic components;
Z is an m-valent radical of a polyurethane polymer PUR having isocyanate groups after removal of m isocyanate groups; and
index m is a value of 1 to 4,
combining the reaction product as a reaction partner for a polyurethane polymer having an isocyanate group or for a polyisocyanate in preparation of a silane-functional polymer.

11. A composition for production of adhesives, sealants or coatings comprising: at least one polymer of the formula (I) as claimed in claim 1.

12. The composition as claimed in claim 11, wherein a proportion of the polymer of the formula (I) is 5 to 80% by weight, based on the overall composition.

13. The composition as claimed in claim 11, wherein the composition additionally comprises: at least one filler.

14. The composition as claimed in claim 11, wherein the composition comprises: at least one catalyst for crosslinking of the polymers of the formula (I) by moisture.

15. The composition as claimed in claim 11, configured as an adhesive, sealant or coating.

16. A polymer as claimed in claim 2, wherein the R³ radical is a methyl or ethyl group.

17. A polymer as claimed in claim 16, wherein X is a methylene, n-propylene, 3-aza-n-hexylene or 3-aza-n-pentylene group.

18. A polymer as claimed in claim 17, wherein the index m is a value of 1 or 2.

19. A polymer as claimed in claim 18, wherein the polyurethane polymer PUR is obtained from at least one polyol and at least one polyisocyanate, said polyisocyanate being metered in such that isocyanate groups thereof are present in a stoichiometric excess in relation to hydroxyl groups of the polyol.

20. The composition as claimed in claim 11, wherein a proportion of the polymer of the formula (I) is 10 to 50% by weight, based on the overall composition.

21. The composition as claimed in claim 11, wherein a proportion of the polymer of the formula (I) is 7 to 70% by weight, based on the overall composition.
